(19) United States
(12) Patent Application Publication
(10) Pub. No.: US 2025/0260352 A1
(43) Pub. Date: Aug. 14, 2025

(54) METHOD FOR OPERATING A BRUSHLESS ELECTRIC MOTOR, ELECTRONIC REGULATING AND/OR CONTROL DEVICE, AND POWER TOOL

(71) Applicant: Metabowerke GmbH, Neurtingen (DE)

(72) Inventors: Chunyu ZHANG, Leonberg (DE); Bernd WIESNER, Owen (DE); Peter EBERHARDT, Altbach (DE)

(73) Assignee: Metabowerke GmbH, Neurtingen (DE)

(21) Appl. No.: 19/016,434

(22) Filed: Jan. 10, 2025

(30) Foreign Application Priority Data
Jan. 12, 2024 (DE) 102024100907.1

(51) Int. Cl. H02P 27/08

(52) U.S. Cl. CPC H02P 27/085

(57) ABSTRACT

The invention relates to a method for operating a brushless electric motor (4), wherein a mains input voltage (Uₘₐᵢₙₛ) is rectified into a DC voltage by means of a rectifier (1), which DC voltage is delivered, via an intermediate circuit (2) which comprises an intermediate circuit capacitor (C_{ZK}), to an inverter (3) which is electrically connected to the electric motor (4) and which is controlled by an electronic regulating and/or control device (5) for supplying and/or regulating the electric motor (4), wherein the mains input voltage (Uₘₐᵢₙₛ) is progressively measured and a quality of the measured mains input voltage (Uₘₐᵢₙₛ) is determined and wherein, depending on the quality of the measured mains input voltage (Uₘₐᵢₙₛ), the brushless electric motor (4) is operated in a first operating mode or in at least one further operating mode.

The present invention relates to a method for operating a brushless electric motor. Moreover, the invention also relates to an electronic regulating and/or control device, and to a power tool.

EP 2 784 931 B1 relates to a method and a control circuit for controlling a brushless electric motor.

A power tool is known from DE 10 2020 214 109 A1, which is configured for connecting to a mains voltage and which comprises a rectifier assembly having an intermediate circuit for supplying an intermediate circuit voltage on the basis of the mains voltage.

In brushless hard-wired electric drive systems, the mains voltage is rectified into a DC voltage by means of a rectifier, and is buffered in an “intermediate circuit”. The DC voltage is then converted into a three-phase voltage, and is applied to the electric motor of the drive system.

The intermediate circuit can comprise, for example, an intermediate circuit capacitor which, in particular, is employed for smoothing the rectified mains voltage. Various approaches are available for dimensioning the intermediate circuit. According to a first approach, the intermediate circuit is dimensioned such that the intermediate circuit voltage is virtually constant. In particular, this enables the achievement of virtually constant phase currents for energizing the electric motor and, as a result, of a virtually constant torque characteristic of the electric motor. However, a capacitor which is rated to this magnitude, on the grounds of limited structural space, can only be accommodated in a hand-held power tool with difficulty.

According to a second approach, the intermediate circuit can be dimensioned with a low rating, such that the intermediate circuit voltage follows the mains voltage, in particular the rectified mains voltage. However, a low intermediate circuit rating of this type can result in the formation of an oscillating circuit associated with impedances.

The inductance of the feeder line, in combination with the intermediate circuit capacitor, can generate an oscillatory configuration. The natural resonance of this oscillating circuit is dependent upon the product of the inductance of the feeder line and the capacitance of the intermediate circuit capacitor. As damping, in general, is relatively limited, oscillation processes in drives of this type can be problematic and, as a result of a corresponding voltage increase, can exceed the power limits of semiconductor components employed, thus resulting in the potential destruction thereof. The oscillating circuit is excited, on the one hand, by the motor controller which, as a result of control processes, generates an inconsistent current consumption from the intermediate circuit capacitor, and by the rectifier, which abruptly commutates a charging current of the intermediate circuit capacitor from the power grid, in the event of a rising mains voltage. Operation of a brushless drive having a low-rated intermediate circuit, for example at a capacity in excess of 1 kW, can be unstable as a result of the impedance of the mains feeder line.

From practice, in the interests of ensuring system stability, it is known for a “line conditioner” to be arranged up-circuit of the drive system or of the electrical device. In many cases, however, the employment of an additional device of this type is not desirable, particularly on the grounds of costs.

Accordingly, the fundamental object of the present invention is the provision of a method of the above-mentioned type which eliminates the disadvantages of the prior art and which, in particular, enables a stable operation of a brushless electric motor having a low-rated intermediate circuit, with no additional devices.

According to the invention, this object is achieved by claim 1.

According to the invention, a method is proposed for operating a brushless electric motor, wherein a mains input voltage is rectified into a DC voltage by means of a rectifier, which DC voltage is delivered, via an intermediate circuit which comprises an intermediate circuit capacitor, to an inverter which is electrically connected to the electric motor and which is controlled by an electronic regulating and/or control device for supplying and/or regulating the electric motor, wherein the mains input voltage is progressively measured and a quality of the measured mains input voltage is determined and wherein, depending on the quality of the measured mains input voltage, the brushless electric motor is operated in a first operating mode or in at least one further operating mode.

By means of the measures according to the invention, a stable operation of a brushless electric motor at capacities in excess of 1 kW having a standard inverter and a low-rated intermediate circuit is enabled. A dynamic switchover of the operating mode is proposed, which ensures the maximum power of the drive at all times. The switchover is deduced from a determination and appraisal of power grid quality. All grid conditions can be automatically compensated. Under poor grid conditions, no additional devices, such as e.g. line conditioners or similar, are required. Only limited additional costs are generated, as the solution is exclusively software-based, and ensures that the optimum power of the drive is available at all times, without complex hardware. Moreover, no additional structural space is required, which is particularly advantageous in hand-held tools or devices. Only a measurement of the mains input voltage is executed. Additionally, only those signals which are required in any event for operating a field-oriented control (FOC) or block commutation (currents, voltages, rotor position) are necessary. The power range can be equal to or greater than 1 kW to 4 kW, or even higher. The range of application can encompass a mains impedance of less than 1 mH up to approximately 20 mH. The invention can be employed in FOC- or block-commutated motor controllers (in mains or accumulator operation). Motor controllers can be both sensor-based and sensorless.

In the first operating mode, the inverter can be switched to a continuous operation.

In the at least one further operating mode:
a) the inverter can be switched to an intermittent operation, in which the inverter is intermittently switched on and off in an alternating manner; and/or
b) control parameters, target values or threshold values for the operation of the electric motor can be varied, particularly in a proportional manner depending on the determined quality of the measured mains input voltage.

The variation of target values or threshold values for operating the electric motor in step b) can comprise one or more of the following steps:
a target or no-load speed of the electric motor is reduced, particularly in a proportional manner;
current limiting values are reduced, particularly in a proportional manner; and
overload switch-off limits are reduced, particularly in a proportional manner.

If a high mains input voltage quality is present, a switchover to the first operating mode can be carried out, and otherwise, particularly in response to the ascertainment of a reduced mains input voltage quality, a switchover to the corresponding at least one further operating mode can be carried out.

Switchover between the operating modes can be executed in a stepless or discrete manner.

A stepless switchover between operating modes can be executed as a gradual transition from one operating state to the other. This can be executed proportionally, according to the actual mains voltage quality thus evaluated. Multiple or numerous discrete and separate operating states can also be provided.

For determining the quality of the mains input voltage, a signal curve of the measured mains input voltage can be compared with an anticipated or known, in particular an ideal sinusoidal curve of the mains input voltage.

At least one fault component can be captured in a signal section of the measured mains input voltage, and evaluated by means of a metric function or evaluation function, wherein the quality of the mains input voltage is evaluated as poor, if the metric function or evaluation function exceeds a predetermined limiting value.

In the signal section, a fundamental orientation or signal curve of the measured mains input voltage can be at least theoretically known and/or a monotonic signal curve of the measured mains input voltage can be anticipated, wherein the fault component to be evaluated is in opposition to, or deviates from the known orientation, or deviates from the known or monotonic signal curve.

The metric function or evaluation function for the fault component can at least consider the following:
a time interval which is required, further to a first transient maximum value, to achieve a second, in particular a higher maximum value of the deviation;
an absolute maximum value of the deviation achieved or a maximum depth of the fault component achieved; and/or
an integral between the measured signal curve and the value of a first transient maximum, for such time as the measured signal curve remains below the value of the first maximum.

The time interval, the depth or the integral can additionally be evaluated with a weighting function.

In the signal section, multiple fault components thus captured can be evaluated by means of a common metric function or evaluation function, which can be compared with a common predetermined limiting value.

The mains input voltage can be measured in a discrete-time manner at a sampling rate in excess of 5 kHz, preferably at a sampling rate of 20 KHz, and/or the mains input voltage can be measured at a sampling rate which matches a pulse-width modulation of the electric motor. The employment of higher sampling rates can generate superior results.

The mains input voltage can be scanned in an equidistant manner. The sampling intervals can thus be invariably of an equal length, and highly frequent in relation to the influencing signal.

At least one differential value between a current measured value of the mains input voltage and at least one preceding measured value of the mains input voltage can be determined, wherein the quality of the mains input voltage is evaluated as poor, in the event that an absolute magnitude of at least one of the differential values thus determined exceeds a voltage limiting value which is assigned to the respective preceding measured values or to the respective differential values.

Differential values for a number between 1 and 10, in particular for 4 preceding measured values of the mains input voltage can be determined.

Alternatively or additionally, the quality of the mains input voltage can be evaluated as poor, in the event that an absolute magnitude of a measured value of the mains input voltage exceeds a voltage limiting value, in particular to an amount of approximately 120% of a peak value of the mains input voltage.

In claim 18, an electronic regulating and/or control device is disclosed for controlling, supplying and/or regulating an electric motor, which is configured to execute the method according to the invention for operating the electric motor.

The electronic regulating and/or control device can be configured to receive a measurement signal which is characteristic of the mains input voltage.

Finally, the present invention also relates to a power tool having the features of claim 20.

The power tool can comprise a display device, which can be electrically connected to an electronic regulating and/or control device, and by means of which the present operating mode of the electric motor (4) can be displayed.

By means of a display device of this type, the user can be notified of the instantaneous quality of the power supply of the device. This can be carried out, for example, by means of a red flashing LED, or similar, which is arranged on the device.

Additionally, it should be observed that terms such as “incorporating”, “comprising” or “having” do not exclude further features or steps. Moreover, the terms “a” or “the”, employed in reference to a singularity of steps or features, do not exclude a plurality of features or steps, and vice versa.

Further features and advantages of the invention proceed from the following description of an exemplary embodiment of the invention, and from the sub-claims.

The invention is described in greater detail hereinafter, with reference to the attached figures. The figures show multiple features of the invention in mutual combination. Naturally, however, a person skilled in the art will also be capable of considering these features in mutual isolation and, optionally, of executing the combination thereof to form further appropriate sub-combinations, without the necessity of any inventive activity for this purpose.

In the figures, schematically:

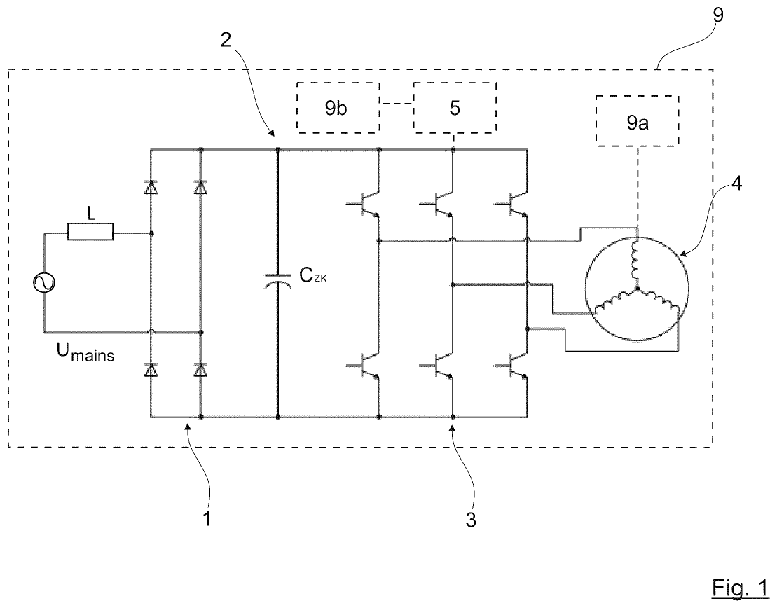

FIG. 1 shows a circuit diagram of a rectifier, an intermediate circuit and an inverter for operating a brushless electric motor;

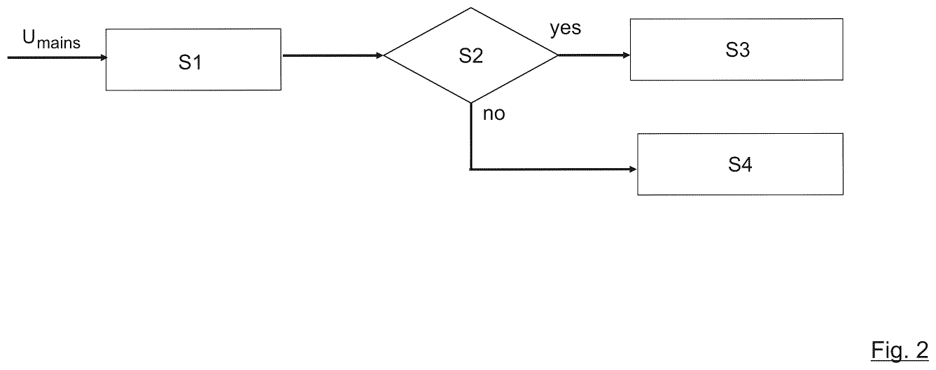

FIG. 2 shows a flow diagram illustrating a method according to the invention for operating the brushless electric motor;

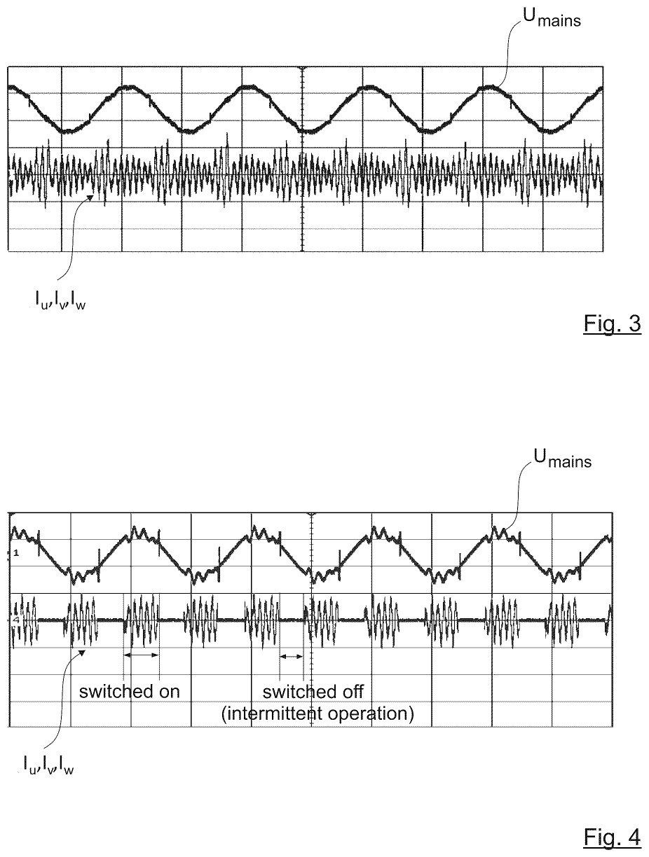

FIG. 3 shows an illustrative representation of a first operating mode, in particular of a continuous operating mode, in the context of the method according to the invention for operating the brushless electric motor;

FIG. 4 shows an illustrative representation of a further operating mode, in particular of an intermittent operating mode, in the context of the method according to the invention for operating the brushless electric motor;

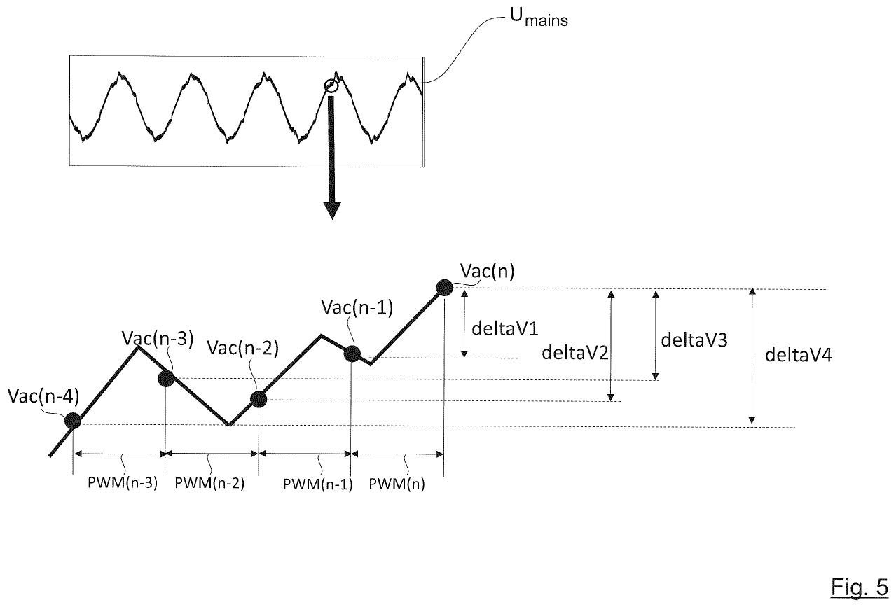

FIG. 5 shows an illustrative representation of an evaluation of the quality of a mains input voltage, according to a first embodiment;

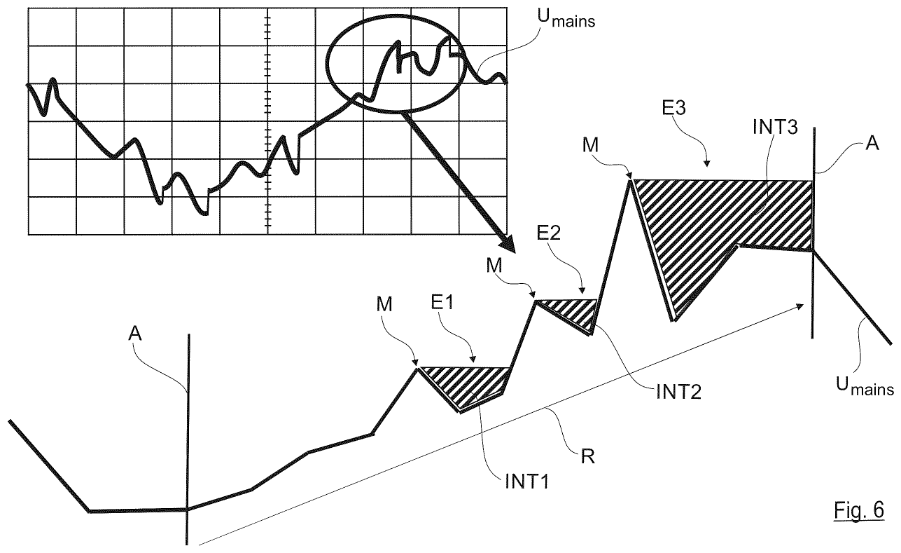

FIG. 6 shows an illustrative representation of an evaluation of the quality of the mains input voltage, according to a second embodiment; and

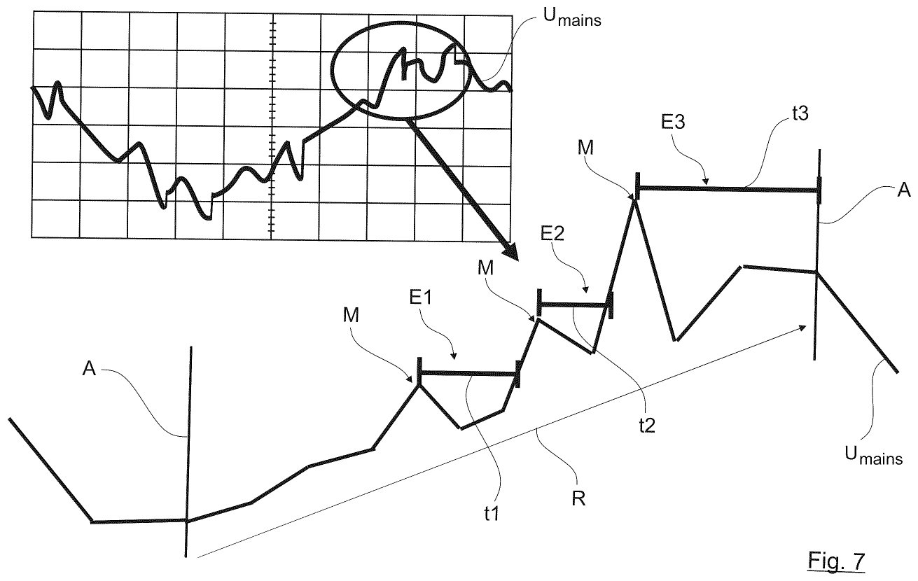

FIG. 7 shows an illustrative representation of an evaluation of the quality of the mains input voltage, according to a third embodiment.

In the figures, functionally equivalent elements are identified by the same reference symbols.

FIG. 1 shows a representation of a simplified circuit diagram of a rectifier 1, an intermediate circuit 2 and an inverter 3 for operating a brushless electric motor 4. A mains input voltage Uₘₐᵢₙₛ is rectified into a DC voltage by means of the rectifier 1, which DC voltage is delivered, via the intermediate circuit 2 which comprises an intermediate circuit capacitor C_{ZK}, to the inverter 3, which is electrically connected to the electric motor 4, which is controlled by an electronic regulating and/or control device 5, which is represented in a highly simplified manner by a broken outline, for supplying and/or regulating the electric motor 4. As can be seen from FIG. 1, the mains input voltage Uₘₐᵢₙₛ can comprise an inductance L which, in combination with the intermediate circuit capacitor C_{ZK}, can generate an oscillatory configuration. The method according to the invention for operating the brushless electric motor 4 can be implemented in the form of a pure software solution, and ensures a stable operation.

According to the invention, the mains input voltage Uₘₐᵢₙₛ is measured progressively, and a quality of the measured mains input voltage Uₘₐᵢₙₛ is determined wherein, depending on the quality of the measured mains input voltage Uₘₐᵢₙₛ, the brushless electric motor 4 is operated in a first operating mode, or in at least one further operating mode.

The method according to the invention can be employed in a power tool 9, which is represented by a broken outline, in particular in a hand-held power tool 9, at least having a tool 9a, which is also represented by a broken line, the electric motor 4 for driving the tool 9a and the electronic regulating and control device 5 for controlling, supplying and/or regulating the electric motor 4, wherein the power tool 9 is configured for connecting to the mains input voltage Uₘₐᵢₙₛ, and further comprises the rectifier 1 having the intermediate circuit 2, which comprises the intermediate circuit capacitor C_{ZK}, and which comprises the inverter 3 which is electrically connected to the electric motor 4, and wherein the mains input voltage Uₘₐᵢₙₛ is rectified by means of the rectifier 1 into a DC voltage, which DC voltage is delivered via the intermediate circuit to the inverter 3, which is controlled by the electronic regulating and/or control device 5 for supplying and/or regulating the electric motor 4.

Moreover, the power tool 9 can be provided with a display device 9b, which is electrically connected to the electronic regulating and/or control device 5, and by means of which the present operating mode of the electric motor 4 can be displayed, e.g. to a user. The display device 9b can be embodied, for example, as a light-emitting diode (LED) which is arranged on the power tool 9 or on the housing thereof. In the event that the quality of the mains input voltage Uₘₐᵢₙₛ is inadequate, this LED e.g. can flash red.

The electronic regulating and/or control device 5 can be designed for executing the method according to the invention for operating the electric motor 4. The electronic regulating and/or control device 5 can further be designed to receive a measurement signal which is characteristic of the mains input voltage Uₘₐᵢₙₛ.

FIG. 2 shows a simplified flow diagram for illustrating the method according to the invention for operating the brushless electric motor.

In a process step S1, the quality of the measured mains input voltage Uₘₐᵢₙₛ is determined. To this end, in process step S1, measured values of the mains input voltage Uₘₐᵢₙₛ are progressively received by way of input variables. The mains input voltage Uₘₐᵢₙₛ can be measured in a discrete-time manner with a sampling rate in excess of 5 kHz, preferably at a sampling rate of 20 kHz, and/or with a sampling rate which matches a pulse-width modulation of the electric motor 4.

In a process step S2, a decision is executed as to whether, in the event that a good quality of the mains input voltage Uₘₐᵢₙₛ is in force (“yes” path in FIG. 2), a progression to a process step S3 is to be implemented, in which a switchover to the first operating mode is to be executed. Otherwise, i.e. in the event that a good quality of the mains input voltage Uₘₐᵢₙₛ is not in force (“no” path in FIG. 2), in a process step S4, particularly according to the reduced quality of the mains input voltage Uₘₐᵢₙₛ thus determined, a switchover to the corresponding at least one further operating mode is executed.

In the first operating mode, the inverter 3 can be switched to a continuous operation. FIG. 3, in an exemplary and simplified manner, represents the curves of the mains input voltage Uₘₐᵢₙₛ and of the phase currents Iᵤ, Iᵥ, I_{w} in a continuous operation of the inverter 3.

In the at least one further operating mode:
a) the inverter 3 can be switched to an intermittent operation, in which the inverter 3 can be intermittently switched on and off in an alternating manner; and/or
b) control parameters, target values or threshold values for the operation of the electric motor 4 can be varied, particularly in a proportional manner according to the quality of the measured mains input voltage Uₘₐᵢₙₛ thus determined.

FIG. 4, in an exemplary and simplified manner, represents the characteristics of the mains input voltage Uₘₐᵢₙₛ and of the phase currents Iᵤ, Iᵥ, I_{w} in an intermittent operation of the inverter 3.

The variation of target values or threshold values for operating the electric motor 4 in step b) can comprise one or more of the following steps:
a target or no-load speed of the electric motor 4 is reduced, particularly in a proportional manner;
current limiting values are reduced, particularly in a proportional manner; and
overload switch-off limits are reduced, particularly in a proportional manner.

The switchover between operating modes can be stepless or discrete.

For determining the quality of the mains input voltage Uₘₐᵢₙₛ, a signal curve of the measured mains input voltage can be compared with an anticipated or known, in particular an ideal sinusoidal curve of the mains input voltage Uₘₐᵢₙₛ.

FIG. 5 shows an illustrative representation of an evaluation of the quality of a mains input voltage Uₘₐᵢₙₛ, according to a first embodiment. The lower part of FIG. 5 shows a simplified sectional enlargement of the circled area of the curve of the mains input voltage Uₘₐᵢₙₛ represented in the upper part of FIG. 5. As can be seen from FIG. 5, the mains input voltage Uₘₐᵢₙₛ is scanned in an equidistant manner, e.g. at sampling rates which match the pulse-width modulation of the electric motor 4, at intervals PWM (n−3), PWM (n−2), PWM (n−1), PWM (n).

As can further be seen from FIG. 5, at least one differential value deltaV1-deltaV4 between a current measured value Vac(n) of the mains input voltage Uₘₐᵢₙₛ and at least one preceding measured value Vac(n−4), Vac(n−3), Vac(n−2), Vac(n−1) of the mains input voltage Uₘₐᵢₙₛ can be determined, wherein the quality of the mains input voltage Uₘₐᵢₙₛ is evaluated as poor, in the event that an absolute magnitude of at least one of the differential values deltaV1-deltaV4 thus determined exceeds a voltage limiting value which is assigned to the respective preceding measured values Vac(n−4), Vac(n−3), Vac(n−2), Vac(n−1) or to the respective differential values deltaV1-deltaV4. Differential values deltaV1-deltaV4 for a number between 1 and 10, in particular for 4 preceding measured values Vac(n−4), Vac(n−3), Vac(n−2), Vac (n−1) of the mains input voltage Uₘₐᵢₙₛ can be ascertained.

Alternatively or additionally, the quality of the mains input voltage Uₘₐᵢₙₛ can be evaluated as poor, in the event that an absolute magnitude of a measured value of the mains input voltage Uₘₐᵢₙₛ exceeds a voltage limiting value, in particular to an amount of approximately 120% of a peak value of the mains input voltage Uₘₐᵢₙₛ.

FIGS. 6 and 7 show illustrative representations of an evaluation of the quality of a mains input voltage according to a second and third embodiment. In each case, the lower part of FIGS. 6 and 7 shows a simplified sectional enlargement of the circled area of the curve of the mains input voltage Uₘₐᵢₙₛ represented in the upper part of FIGS. 6 and 7.

As can be seen from FIGS. 6 and 7, at least one fault component E1-E3 can be captured in a signal section A of the measured mains input voltage Uₘₐᵢₙₛ, and evaluated by means of a metric function or evaluation function, wherein the quality of the mains input voltage Uₘₐᵢₙₛ is evaluated as poor, if the metric function or evaluation function exceeds a predetermined limiting value.

In the signal section A, a fundamental orientation R or signal curve of the measured mains input voltage Uₘₐᵢₙₛ can be at least theoretically known and/or a monotonic signal curve of the measured mains input voltage Uₘₐᵢₙₛ can be anticipated, wherein the fault component E1-E3 to be evaluated is in opposition to, or deviates from the known orientation R, or deviates from the monotonic signal curve.

The metric function or evaluation function for the fault component E1-E3 can at least consider the following:
a time interval t1-t3 which is required, further to a first transient maximum value M, to achieve a second, in particular a higher maximum value of the deviation (see FIG. 7);
an absolute maximum value of the deviation achieved or a maximum depth of the fault component E1-E3 achieved (not represented); and/or
an integral INT1-INT3 between the measured signal curve and the value of a first transient maximum M, for such time as the measured signal curve remains below the value of the first maximum M (see FIG. 6).

The time interval t1-t3, the depth or the integral INT1-INT3 can additionally be evaluated with a weighting function.

In the signal section A, multiple fault components E1-E3 thus captured can be evaluated by means of a common metric function or evaluation function, which can be compared with a common predetermined limiting value.

### LIST OF REFERENCE SYMBOLS

1 Rectifier
2 Intermediate circuit
3 Inverter
4 Electric motor
5 Electronic regulating and/or control device
9 Power tool
9a Tool
9b Display device
Uₘₐᵢₙₛ Mains input voltage
C_{ZK} Intermediate circuit capacitor
S1-S4 Process steps
Iᵤ, Iᵥ, I_{w} Phase currents
PWM (n−3)-PWM (n) Time intervals
Vac(n−4)-Vac(n) Measured values
deltaV1-deltaV4 Differential values
R Orientation
A Signal section
E1-E3 Fault components
INT1-INT3 Integrals
t1-t3 Time intervals
M Transient maximum

1. Method for operating a brushless electric motor (4), wherein a mains input voltage (Uₘₐᵢₙₛ) is rectified into a DC voltage by means of a rectifier (1), which DC voltage is delivered, via an intermediate circuit (2) which comprises an intermediate circuit capacitor (C_{ZK}), to an inverter (3) which is electrically connected to the electric motor (4) and which is controlled by an electronic regulating and/or control device (5) for supplying and/or regulating the electric motor (4), wherein the mains input voltage (Uₘₐᵢₙₛ) is progressively measured and a quality of the measured mains input voltage (Uₘₐᵢₙₛ) is determined and wherein, depending on the quality of the measured mains input voltage (Uₘₐᵢₙₛ), the brushless electric motor (4) is operated in a first operating mode or in at least one further operating mode.

2. Method according to claim 1 wherein, in the first operating mode, the inverter (3) is switched to a continuous operation.

3. Method according to claim 1 or 2 wherein, in the at least one further operating mode:
a) the inverter (3) is switched to an intermittent operation, in which the inverter (3) is intermittently switched on and off in an alternating manner; and/or
b) control parameters, target values or threshold values for the operation of the electric motor (4) are varied, particularly in a proportional manner depending on the determined quality of the measured mains input voltage (Uₘₐᵢₙₛ) thus ascertained.

4. Method according to claim 3, wherein the variation of target values or threshold values for operating the electric motor (4) in step b) comprises one or more of the following steps:
a target or no-load speed of the electric motor (4) is reduced, particularly in a proportional manner;
current limiting values are reduced, particularly in a proportional manner; and
overload switch-off limits are reduced, particularly in a proportional manner.

5. Method according to one of claims 1 to 4 wherein, in the event that a good quality of the mains input voltage (Uₘₐᵢₙₛ) is present, a switchover to the first operating mode is executed, and otherwise, particularly depending on a reduced quality of the mains input voltage (Uₘₐᵢₙₛ) thus determined, a switchover to the corresponding at least one further operating mode is executed.

6. Method according to one of claims 1 to 5, wherein the switchover between operating modes is executed in a stepless or discrete manner.

7. Method according to one of claims 1 to 6 wherein, for determining the quality of the mains input voltage (Uₘₐᵢₙₛ), a signal curve of the measured mains input voltage (Uₘₐᵢₙₛ) is compared with an anticipated or known, in particular an ideal sinusoidal curve of the mains input voltage (Uₘₐᵢₙₛ).

8. Method according to one of claims 1 to 7, wherein at least one fault component (E1-E3) is captured in a signal section (A) of the measured mains input voltage (Uₘₐᵢₙₛ), and is evaluated by means of a metric function or evaluation function, wherein the quality of the mains input voltage (Uₘₐᵢₙₛ) is evaluated as poor, if the metric function or evaluation function exceeds a predetermined limiting value.

9. Method according to claim 8 wherein, in the signal section (A), a fundamental orientation (R) or signal curve of the measured mains input voltage (Uₘₐᵢₙₛ) are at least theoretically known and/or a monotonic signal curve of the measured mains input voltage (Uₘₐᵢₙₛ) is anticipated, wherein the fault component (E1-E3) to be evaluated is in opposition to, or deviates from the known orientation (R), or deviates from the known or monotonic signal curve.

10. Method according to claim 9, wherein the metric function or the evaluation function for the fault component (E1-E3) at least considers the following:
a time interval (t1-t3) which is required, further to a first transient maximum value (M), to achieve a second, in particular a higher maximum value of the deviation;
an absolute maximum value of the deviation achieved or a maximum depth of the fault component (E1-E3) achieved; and/or
an integral (INT1-INT3) between the measured signal curve and the value of a first transient maximum (M), for such time as the measured signal curve remains below the value of the first maximum (M).

11. Method according to claim 10, wherein the time interval (t1-t3), the depth or the integral (INT1-INT3) are additionally evaluated with a weighting function.

12. Method according to one of claims 8 to 11 wherein, in the signal section (A), multiple fault components (E1-E3) thus captured are evaluated by means of a common metric function or evaluation function, which can be compared with a common predetermined limiting value.

13. Method according to one of claims 1 to 12, wherein the mains input voltage (Uₘₐᵢₙₛ) is measured in a discrete-time manner at a sampling rate in excess of 5 kHz, preferably at a sampling rate of 20 kHz, and/or the mains input voltage (Uₘₐᵢₙₛ) is measured at a sampling rate which matches a pulse-width modulation of the electric motor (4).

14. Method according to one of claims 1 to 13, wherein the mains input voltage (Uₘₐᵢₙₛ) is scanned in an equidistant manner.

15. Method according to one of claims 1 to 14, wherein at least one differential value (deltaV1-deltaV4) between a current measured value (Vac(n)) of the mains input voltage (Uₘₐᵢₙₛ) and at least one preceding measured value (Vac(n−4), Vac(n−3), Vac(n−2), Vac(n−1)) of the mains input voltage (Uₘₐᵢₙₛ) is determined, wherein the quality of the mains input voltage (Uₘₐᵢₙₛ) is evaluated as poor, in the event that an absolute magnitude of at least one of the differential values (deltaV1-deltaV4) thus determined exceeds a voltage limiting value which is assigned to the respective preceding measured values (Vac(n−4), Vac(n−3), Vac(n−2), Vac (n−1)) or to the respective differential values (deltaV1-deltaV4).

16. Method according to claim 15, wherein differential values (deltaV1-deltaV4) for a number between 1 and 10, in particular for 4 preceding measured values (Vac(n−4), Vac(n−3), Vac(n−2), Vac (n−1)) of the mains input voltage (Uₘₐᵢₙₛ) are determined.

17. Method according to one of claims 1 to 16, wherein the quality of the mains input voltage (Uₘₐᵢₙₛ) is evaluated as poor, in the event that an absolute magnitude of a measured value of the mains input voltage (Uₘₐᵢₙₛ) exceeds a voltage limiting value, in particular to an amount of approximately 120% of a peak value of the mains input voltage (Uₘₐᵢₙₛ).

18. Electronic regulating and/or control device (5) for controlling, supplying and/or regulating an electric motor (4) which is configured to execute a method for operating the electric motor (4) according to one of claims 1 to 17.

19. Electronic regulating and/or control device (5) according to claim 18, which is configured to receive a measurement signal which is characteristic of the mains input voltage (Uₘₐᵢₙₛ).

20. Power tool (9), in particular a hand-held power tool (9), at least having a tool (9a), an electric motor (4) for driving the tool (9a) and an electronic regulating and/or control device (5) according to claim 18 or 19 for controlling, supplying and/or regulating the electric motor (4), wherein the power tool (9) is configured for connecting to the mains input voltage (Uₘₐᵢₙₛ), and further comprises a rectifier (1) having an intermediate circuit (2), which comprises an intermediate circuit capacitor (C_{ZK}), and which comprises an inverter (3) which is electrically connected to the electric motor (4), and wherein the mains input voltage (Uₘₐᵢₙₛ) is rectified by means of the rectifier (1) into a DC voltage, which DC voltage is delivered via the intermediate circuit (2) to the inverter (3), which is controlled by the electronic regulating and/or control device (5) for supplying and/or regulating the electric motor (4).

21. Power tool (9) according to claim 20, characterized by a display device (9b) which is electrically connected to the electronic regulating and/or control device (5) and by means of which the present operating mode of the electric motor (4) can be displayed.
